(19) United States
(12) Patent Application Publication
(10) Pub. No.: US 2010/0122487 A1
(43) Pub. Date: May 20, 2010

(54) Holder capable of holding and allowing a jig pole to move

(76) Inventor: Richard David Snider, Bruce, WI (US)

Correspondence Address: Richard D. Snider, N 6564 Dearhamer Rd., Bruce, WI, 54819, US

(21) Appl. No.: 12/313,378

(22) Filed: Nov. 20, 2008

(51) Int. Cl. A01K 91/06; A01K 97/10

(52) U.S. Cl. 43/19.2; 43/21.2

(57) ABSTRACT

A holder is disclosed which is capable of holding and allowing a jig pole to move. The holder includes a first member having an attachment mechanism rotatably secured to a first end and a holding member rotatably secured to a second end. The holding member also has a pair of spaced apart, upright legs each having a terminal end with a notch formed therein. The holder also includes a second member which has a shaft joined to a collar. The shaft is sized to fit within each of the notches and the collar is of sufficient size to encircle the handle of the jig pole. The holder further includes an adjustable member capable of securing the collar to the handle, forward of the fishing reel, such that the weight of the fishing reel retains the jigging pole at an acute angle relative to a body of water.

### FIELD OF THE INVENTION

This invention relates to a holder capable of holding and allowing a jig pole to move up and down.

### BACKGROUND OF THE INVENTION

Today, fishing is very popular. Ice fishing, also referred to as hard water fishing, is also becoming more popular with the general population. The explosive growth in the sales of snow mobiles and all terrain vehicles (ATV's) has made it much easier for people to quickly, efficiently and comfortably transport themselves, their gear and their friends to remote fishing locations. Once at a desired fishing hot spot, gas operated augers allow a person to quickly and effortlessly drill multiple holes through the ice regardless of the thickness of the ice. Many shanties also have movable or removable floor panels that can be opened or pivoted out of the way to expose the drilled holes. An ice fisherman can now travel to his or her desired fishing spot, drill several holes and set up his or her shanty in a matter of minutes. This ability, coupled with the advancements in ice fishing shanties has made the sport more enjoyable and bearable against the elements. Today, many ice fishing shanties are constructed on a sturdy plastic shell or sled. Such shells have aluminum poles secured thereto which are covered by a pliable fabric that forms a tent or canopy as the aluminum poles are raised. Such shanties are also equipped with one or more raised seats to position the fisherman adjacent to one or more drilled holes.

Once a hole is drilled or formed through the ice, a fisherperson can position his or her shanty adjacent to or over the holes and climb into the shanty and sit down. The fisherperson can then employ one or two jig poles, which are properly baited, to entice the fish to take the bait. A jig pole is typically a short fishing pole having an overall length of about two feet. Each jig pole has a handle designed to have a fishing reel, of a predetermined weight, secured thereto. The handle also has a first end with a flexible, elongated shaft extending outward therefrom and an oppositely aligned terminal end. The flexible, elongated shaft is typically constructed of fiberglass or graphite and has one or more eye loops secured thereto. A fishing line is advanced from the fishing reel through the eye loops and has a hook or an artificial lure, and/or a weight, secured approximate its free end. A natural bait, such as a live minnow, a dead minnow, a grub, a worm such as a wax worm, etc. can be secured to the hook or artificial lure. The hook, bait and a split shot weight, or a lure that is or is not baited can be lowered into the hole to a desired depth, usually several inches above the bottom sediment or vegetation of the lake, pond, stream, river, etc. At this time, the fisherperson can start jigging his or her jig pole(s) causing the bait(s) to move or bob up and down jerkily and/or in a rapid or erratic fashion. Such action hopefully will attract the attention of feeding fish which will then bite the bait or lure.

Typically, after several minutes, some fisherperson tire of jigging and will simply hold their jig pole stationary or will position their jig pole against an object to keep it aligned over their ice fishing hole. Now a holder has been invented that will hold and allow a jig pole to pivot, move or vibrate up and down while being retained by a holder at an appropriate angle relative to the body of water. This enables a fisherperson to position the jig pole over the ice fishing hole and continue to jig without having to physically hold the jig pole. The fisherperson can also cause the jig pole to pivot, move or oscillate up and down by intermittently pressing down on the terminal end of the jig pole. The fisherperson can do this by using a finger, a thumb, a bare hand, a hand covered by a glove or mitten, or by using the tip or toe of one of his or her boots. Such flexibility will enable a fisherperson to jig for a longer period of time and therefore increase his or her chances of catching more fish.

The holder can also be used in warm weather as well when the water is free of ice.

### SUMMARY OF THE INVENTION

Briefly, this invention relates to a holder capable of holding and allowing a jig pole to move. A jig pole includes a handle designed to have a fishing reel, of a predetermined weight, secured thereto. The handle also has a first end with a flexible, elongated shaft extending outward therefrom and an oppositely aligned terminal end. The holder includes a first member having an attachment mechanism rotatably secured to a first end and a holding member rotatably secured to a second end. The holding member also has a pair of spaced apart, upright legs each having a terminal end with a notch formed therein. The holder also has a second member which includes a shaft joined to a collar. The shaft is sized to span across the pair of spaced apart, upright legs and fit within each of the notches, and the collar is of sufficient size to encircle the handle of the jig pole. The holder further includes an adjustable member capable of securing the collar to the handle of the jig pole, forward of the fishing reel, such that the weight of the fishing reel retains the jig pole at an acute angle relative to a body of water. The shaft can rotate within the notches to permit the jig pole to move or pivot about the holding member when pressure is applied to the terminal end of the handle.

The general object of this invention is to provide a holder capable of holding and allowing a jig pole to move. A more specific object of this invention is to provide a holder capable of holding and allowing a jig pole, used in ice fishing, to move or pivot so as to move a bait up and down within a body of water when a fisherperson intermittently exerts downward pressure on the terminal end of the handle.

Another object of this invention is to provide a holder for a jig pole which can be use to ice fish or to warm weather fish.

A further object of this invention is to provide a relatively inexpensive holder for a jig pole commonly used in fishing.

Still another object of this invention is to provide a holder for a jig pole which has two primary members which can be easily connected and separated from one another.

Still further, an object of this invention is to provide a holder for a jig pole which can be quickly assembled and is easy to use while ice fishing.

Other objects and advantages of the present invention will become more apparent to those skilled in the art in view of the following description and the accompanying drawings.

### BRIEF DESCRIPTION OF THE DRAWINGS

FIG. 1 is an exploded view of a two piece holder for a jig pole along with a jig pole and an object to which the holder can be removably secured.

FIG. 2 is a perspective view of the assembled holder and jig pole shown secured to an object wherein the jig pole is positioned at an acute angle relative to a body of water.

FIG. 3 is a side view of the first member of the holder having an attachment mechanism rotatably secured adjacent to its first end and a U-shaped holding member rotatably secured adjacent to its second end, a portion of the U-shaped member is cut away to reveal a fastener.

FIG. 4 is a front view of the U-shaped holding member.

FIG. 5 is a front view of the second member of the holder depicting a shaft having two enlarged ends and having a collar secured to the midsection of the shaft, and an adjustable member capable of securing the handle of a jig pole when positioned within the collar.

FIG. 6 is a side view of the second member shown in FIG. 5 taken along line 6-6.

### DETAILED DESCRIPTION OF THE INVENTION

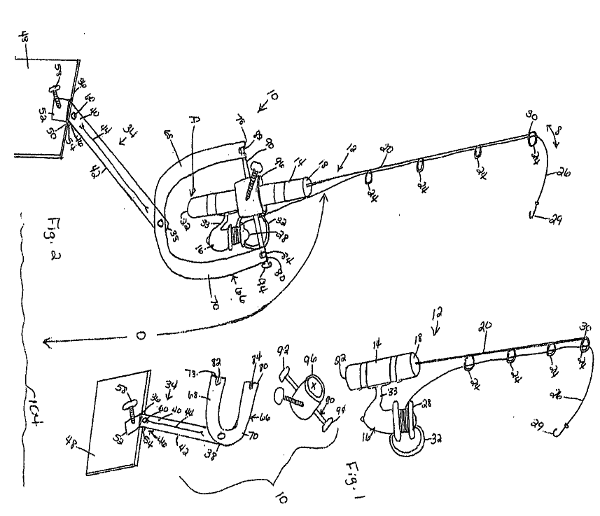

Referring to FIGS. 1 and 2, a holder 10 is shown which is capable of holding and allowing a jig pole 12 to move, pivot, oscillate or vibrate up and down. The jig pole 12 has a handle 14 designed to have a fishing reel 16 of a predetermined weight secured thereto. The handle 14 has a first end 18 with a flexible, elongated shaft or rod 20 extending outward therefrom and an oppositely aligned terminal end 22. The flexible shaft or rod 20 can be constructed of fiberglass, graphite, a composite material or from any other known material that will allow it to be pliable, bendable and flexible. The shaft or rod 20 can have any desired length and diameter. Typically, the jig pole 12 will have a length ranging from between about 18 inches to about 36 inches and a diameter of under about 0.25 inches. Desirably, a jig pole 12 will have a length of from between about 20 inches to about 30 inches and a diameter of under about 0.23 inches. More desirably, a jig pole 12 will have a length of about 24 inches and a diameter of under about 0.2 inches. The shaft or rod 20 can have one or more eye loops 24 secured along its length. A typical jig pole 12 will usually have three, four or more eye loops 24 spaced at varying distances along its length. The eye loops 24 serve as guides for a fishing line 26 which is wound upon a spool 28 of the fishing reel 16. A hook, jig or lure 29 can be tied to the free end of the fishing line 26. The eye loops 24 can be spaced at varying distances along the length of the shaft or rod 20. Typically, the eye loops 24 are spaced closer together as one approaches the tip 30 of the jig pole 12. Alternatively, the eye loops 24 can be evenly spaced along a portion of or along the entire length of the shaft or rod 20, if desired.

It should be noted that the fishing reel 16 is depicted as being a spinning reel having a movable bale 32. However, it should be known to those skilled in the fishing art that any kind of fishing reel can be utilized. Spinning reels and bait casting reels are the two most common type of fishing reels sold today. The fishing reel 16 has a T-shaped attachment arm 33 which is designed to be secured to the handle 14.

Referring now to FIGS. 1-3, the holder 10 includes a first member 34 having a first end 36 and a spaced apart second end 38. The first member 34 can be formed from a variety of materials, including but not limited to: a ferrous metal such as iron; a non-ferrous metal such as brass, bronze, silver or zinc; stainless steel; aluminum; titanium; magnesium; graphite; fiberglass; carbon fibers; various kinds of thermoplastics; non-brittle plastics; acrylics such as LEXAN; wood such as a hard wood; a composite material constructed of two or more different materials, etc. Desirably, the holder 12 is constructed of a ferrous metal and is painter or powder coated to prevent it from rusting. By “ferrous” it is meant a material containing iron, especially with a valence of 2 or a valence lower than in a corresponding ferric compound. By “non-ferrous” it is meant a material not composed of or containing iron; metals other than iron.

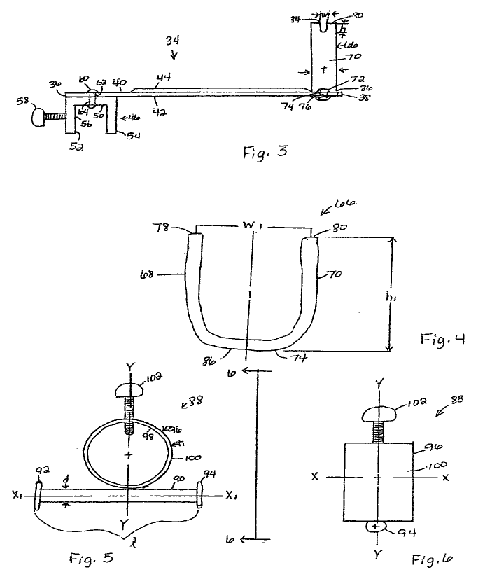

The first member 34 has an upper surface 40 and a lower surface 42, see FIG. 3. The first member 34 can optionally contain a reinforcement rib 44 to provide it with additional strength and stiffness. When the reinforcement rib 44 is present, it can be formed from, be machined into or it can be an additional member added to the first member 34. As depicted in FIGS. 1-3, the reinforcement rib 44 is integral formed from the first member 34 and is depicted as having an inverted V-shaped cross-section. The reinforcement rib 44 can have any desired geometrical cross-section and/or overall shape. The inverted V-shape can be formed by shaping, stamping or pressing the material into the desired shape or profile. As depicted, the reinforcement rib 44 extends along a portion of the length of the first member 34 but stops short of both the first and second ends, 36 and 38 respectively. Desirably, the reinforcement rib 44 will extend along a major portion of the length of the first member 34. It should be recognized by those skilled in the art that the reinforcement rib 44 can be made to extend along the entire length of the first member 34, from the first end 36 to the second end 38, if desired.

An attachment mechanism 46, best shown in FIG. 3, is rotatably secured adjacent to the first end 36. The attachment mechanism 46 is designed to be removable attached or secured to an object 48, see FIGS. 1 and 2. The object 48 can be a stationary object or a movable object. By “stationary” it is meant an object that is not moving. However, it is also possible to secure the attachment mechanism 46 to an object that can be or is capable of being moved, such as the side or transom of a boat. For practical purposes, the holder 12 can be attached to a portion of a movable ice shanty (not shown) which is stationary most of the time but which can be easily moved to another location. The object 48 can also be a movable object such as an all terrain vehicle (ATV), a snow mobile, a truck, a car, a motor cycle, etc. The attachment mechanism 46 can have various shapes or configurations. The attachment mechanism 46 can be aligned perpendicular to the first member 34 or be aligned at an angle thereto. The attachment mechanism 46 is depicted, for illustration purposes only, as a three sided clamp structure having a base 50 with two spaced apart and downwardly extending legs 52 and 54. The legs 52 and 54 can be of the same or different lengths and/or configurations. A threaded bore 56, see FIG. 3, can be formed through one or both of the legs 52 and 54. The threaded bore 56 is sized and configured to receive a fastener 58. The fastener 58 is shown as a thumb screw. By “thumb screw” it is meant a screw designed so that it can be turned with the thumb and fingers. It should be understood that the fastener 58 can also be some other type of fastener, including various screws, nuts, bolts, pins, etc.

One will recognize that the attachment mechanism 46 should be relatively simple in construction. In addition, the attachment mechanism 46 should be configured to be easily attached to and be released from the stationary or movable object 48. The object 48 can be any object including but not limited to: a bucket, a piece of wood, a part of an ice shanty, a fishing box, a chair, a box, a part of an all terrain vehicle (ATV), a part of a snow mobile, a boat, etc. Various types of quick tightening and/or release mechanisms can be utilized to make the attachment mechanism 46 user friendly and easy to operate.

The attachment mechanism 46 can be rotatably secured to the first end 36 of the first member 34 or be secured adjacent to the first end 36 of the first member 34 by a fastener 60. In FIGS. 1-3, the fastener 60 is depicted as a rivet. By “rivet” it is meant a metal bolt or pin having a head on one end, inserted through aligned holes in the pieces to be joined and then hammered on the plain end so as to form a second head. In FIG. 3, an aperture 62 is formed through the first member 34 and a similar size aperture 64, which is coaxially aligned with the aperture 62, is formed through the base 50. These two apertures, 62 and 64 provide a hole through which the fastener 60 can be inserted. It should be understood by those skilled in the art that various other kinds and types of fasteners can also be used. For example, the fastener 60 can be a pin, or a screw and an adjoining nut, etc.

The fastener 60 permits the attachment mechanism 46 to turn, pivot or be rotatably secured to the first member 34. Desirably, the fastener 60 (i.e. rivet) is spaced apart from the reinforcement rib 44 when such a rib is present.

The fastener 60 should allow the attachment mechanism 46 to be rotated at least about 180 degrees, desirably at least about 270 degrees, and most desirably, a full 360 degrees relative to the first member 34. The legs 52 and 54 of the attachment mechanism 46 can be spaced apart by any desired distance. However, it has been found that a spacing of between about 0.5 inches to about 3 inches is sufficient for most objects 48. Desirably, the legs 52 and 54 are spaced from between about 0.75 inches to about 2 inches apart. More desirably, the legs 52 and 54 are spaced about 1 inch apart. As the legs 52 and 54 are spaced farther apart, the length of the fastener 58 can be lengthened to accommodate the extra distance.

Referring now to FIGS. 1-4, the first member 34 also includes a holding member 66 rotatably secured adjacent to the second end 38 of the first member 34. The holding member 66 is depicted having a general U-shape with a pair of spaced apart, upright legs 68 and 70. The holding member 66 can also be referred to as a yoke. The two upright legs 68 and 70 come together at the bottom of the U and form a single piece holding member 66. The two legs 68 and 70 are aligned approximately parallel to one another adjacent to their free ends. The bottom of the U-shaped holding member 66 can be rotatably or pivotably secured to the second end 38 or adjacent to the second end 38 of the first member 34 by a fastener 72. The fastener 72 can vary in shape, size and configuration. As depicted in FIG. 3, the fastener 72 is shown as a rivet. Alternatively, the fastener 72 can be a pin, a screw, a screw and nut fastened together, etc. An aperture 74 is formed through the base or bottom of the U-shaped holding member 66 and another aperture 76 is formed in the first member 34 adjacent to the second end 38. The two apertures 74 and 76 are coaxially aligned and have approximately the same inside diameter so as to receive the fastener 72 (i.e. rivet).

The fastener 72 should allow the U-shaped holding member 66 to rotate, turn or pivot at least about 180 degrees, desirably at least about 270 degrees, and most desirably, a full 360 degrees relative to the first member 34.

Still referring to FIGS. 1-4, each of the upright legs 68 and 70 has a terminal end, 78 and 80 respectively, with a notch 82 and 84 formed therein. Each of the notches 82 and 84 can have almost any desired geometrical shape. In FIG. 3, the notch 84 is depicted as a U-shaped notch having a rounded or semi-circular bottom. The notch 82 can be similar to or identical to the notch 84. Desirably, both of the notches 82 and 84 are identical in size and appearance. The two notches 82 and 84 are aligned along a common centerline so that they can receive and retain a straight shaft simultaneously. The width w and height h dimensions for each of the notches 82 and 84 can vary. However, the particular dimensions for one example of the notches 82 and 84 is a width w dimension ranging from between about 0.5 inches to about 0.75 inches and a height dimension h ranging from between about 0.3 inches to about 0.6 inches. Desirably, the width w dimension will range from between about 0.50 inches to about 0.63 inches and the height dimension h will range from between about 0.40 inches to about 0.55 inches. More desirably, the width w dimension will be about 0.5 inches and the height dimension h will be about 0.5 inches. The purpose of the notches 82 and 84 will be explained shortly.

Referring to FIG. 4, the U-shaped holding member 66 is shown to have a width w₁ dimension and a height h₁ dimension. The width w₁ dimension is measured horizontally between the pair of spaced apart, upright legs 68 and 70. The height h₁ dimension is measured perpendicular to the width w₁ dimension and extends from a bottom surface 86 of the U-shaped holding member 66 to a line that passes between the terminal ends 78 and 80 of the pair of legs 68 and 70. The width w₁ dimension can be less than, equal to or greater than the height h₁ dimension. Desirably, width w₁ dimension is less than the height h₁ dimension. A representative width w₁ dimension ranges from between about 3 inches to about 7 inches and a representative height h₁ dimension ranges from between about 4 inches to about 10 inches. Desirably, the width w₁ dimension ranges from between about 3 inches to about 5 inches and the height h₁ dimension ranges from between about 5 inches to about 8 inches. More desirably, the width w₁ dimension is about 4 inches and the height h₁ dimension is about 5 inches.

Referring back to FIG. 3, one will notice that the U-shaped holding member 66 is aligned perpendicular to the first member 34. In addition, the U-shaped holding member 66 extends outward from the first member 34 in an opposite direction from the attachment mechanism 46. The U-shaped holding member 66 also has a thickness t that can range from between about 1 inch to about 2 inches depending upon the material from which the U-shaped holding member 66 is constructed. It should be understood that one or more members or components of the holder 10 can be constructed of similar or different materials from another member or component. Desirably, the first member 34, the attachment mechanism 46, except for the fastener 58, and the U-shaped holding member 66 will be all constructed from the same material.

Referring now to FIGS. 5 and 6, the holder 10 also includes a second member 88. The second member 88 is separate and distinct from the first member 34. The second member 88 includes a shaft 90 having a first end 92, a spaced apart second end 94, and a length l therebetween. Desirably, the first and second ends, 92 and 94 respectively, are enlarged ends similar to the head on a nail. Each of the enlarged ends 92 and 94 is larger in size than the width w of the notches 82 and 84. This size difference prevents the first or second ends, 92 and 94 respectively, from passing through the adjacent notch 82 or 84. The length l of the shaft 90 is long enough to span across the pair of spaced apart, upright legs 68 and 70. The shaft 90 is designed to bridge across both notches 82 and 84 when inserted therein. The enlarged first and second ends, 92 and 94 respectively, will prevent the shaft 90 from sliding horizontally outward beyond either of the pair of spaced apart, upright legs 68 and 70. The shaft 90 can be a cylindrical shaft having a round or circular cross-section, or it can be formed as a square, rectangular or of some other shape. The shaft 90 can also have any desired geometrical cross-section shape. The shaft 90 has a diameter d or a width dimension, if it is not circular, which is smaller than each of the notches 82 and 84. This size difference will allow the shaft 90 to easily fit within each of the notches 82 and 84 and will allow the shaft 90 to turn, rotate or pivot within the pair of notches 82 and 84. Desirably, the shaft 90 is cylindrical having a diameter of less than about 0.5 inches. Desirably, the shaft 90 has a diameter of about 0.25 inches and each of the first and second ends, 92 and 94 respectively, is an enlarged circular disc having a diameter of at least about 0.75 inches. Such a cylindrical shaft 90 can easily be dropped or slid into the pair of notches 82 and 84 when they have a width dimension of about 0.625 inches.

Still referring to FIGS. 5 and 6, the shaft 90 is secured to a collar 96 having an inside opening 98 which is of sufficient size to encircle the handle 14 of the jig pole 12. By “collar” it is meant an encircling structure, any of various ringlike devices used to limit, guide, or secure another part. The collar 96 can be circular in configuration or have some other geometrical shape. Desirably, the collar 96 is round or circular when viewed from the front. More desirably, the collar 96 is a circular ring having a thickness t₁, measured between the inside diameter 98 and an outside surface 100. The thickness t₁ of the collar 96 can range from between about 0.1 inches to about 0.8 inches. Desirably, the thickness t₁ of the collar 96 can range from between about 0.2 inches to about 0.6 inches. More desirably, the thickness t₁ of the collar 96 is less than about 0.5 inches. In addition, the inside opening or diameter 98 of the collar 96 can range from between about 0.75 inches to about 3 inches. Desirably, the inside opening or diameter 98 of the collar 96 can range from between about 0.8 inches to about 2 inches. More desirably, the inside opening or diameter 98 of the collar 96 is at least about 1 inch.

The collar 96 has a central axis X-X, see FIG. 6, and the shaft 90 has a central axis X₁-X₁, see FIG. 5. The shaft 90 is secured to the outside surface 100 of the collar 96 such that its central axis X₁-X₁ is aligned perpendicular to the central axis X-X of the collar 96.

It should be noted that the shaft 90 can be secured to the collar 96 by various means. For example, the shaft 90 can be welded to the collar 96, be secured to the collar 96 by a mechanical fastener, be secured to the collar 96 by an adhesive, a co-adhesive, a glue, etc.

The holder 10 further includes an adjustable member 102 which is capable of securing the collar 96 to the handle 14 of the jig pole 12. The adjustable member 102 can be any type of fastener or adjustment mechanism. Desirably, the adjustable member 102 is a thumb screw. The adjustable member 102 can be aligned along an axis Y-Y which is aligned perpendicular to the central axis X₁-X₁ of the shaft 90. In addition, the adjustable member 102 should be positioned away from the point of attachment of the shaft 90 to the collar 96. Desirably, the adjustable member 102 is positioned on an opposite side of the fishing rod handle 14 from the fishing reel 16. More desirably, the adjustable member 102 is positioned on the fishing rod handle 14 at about 180 degrees from the fishing reel 16.

### METHOD

The method of using the holder 10 will now be explained. It should be noted that the sequence of some of the steps can vary. First, a person can secure the first member 34 to an object 48 in a desired position adjacent to a hole drilled in the ice located above a body of water 104 or can secure the first member 34 to the side or transom of a boat that is floating on a body of water. The fishing reel 16 is secured to the jig pole 12 if the fishing reel 16 is not already attached to the jig pole 12. Second, the collar 96 is slid along the length of the jig pole 12 starting from the tip 30 downward towards the handle 14 such that the collar 96 is positioned forward of the fishing reel 16, see FIG. 2. The collar 96 will not be able to pass downward beyond the attachment arm 33 of the fishing reel 16. Desirably, the collar 96 will be positioned forward of the attachment arm 33 by a distance of about 0.25 inches or more. The adjustable member 102, i.e. the thumb screw, is then tightened so that the collar 96 is secured to the handle 14 of the jig pole 12. Third, the shaft 90 of the second member 88 is then positioned in the notches 82 and 84 of the U-shaped holding member 66 so that it spans across the legs 68 and 70. The enlarged first and second ends, 92 and 94 respectively, will prevent the shaft 90 from sliding horizontally outward from the legs 68 and 70 of the U-shaped holding member 66. In this position, the weight of the fishing reel 16, which is usually greater than the weight of the jig pole 12, is sufficient to retain the jig pole 12 at an acute angle theta θ relative to a body of water 104, see FIG. 2. By “acute angle” it is meant an angle of less than 90 degrees relative to a body of water 104. Desirably, the angle theta θ ranges from between about 10 degrees to about 75 degrees. More desirably, the angle theta θ ranges from between about 25 degrees to about 65 degrees. Even more desirably, the angle theta θ ranges from between about 30 degrees to about 50 degrees. Most desirably, the angle theta θ is about 45 degrees.

In the case of a spinning reel 16, the bale 32 is opened and the fishing line 26 with the attached hook or lure 29 and/or bait is dropped into the water or through a hole drilled in the ice located above the body of water 104. Usually the hook or lure 29, and any attached bait, is positioned several inches above the bottom surface of the lake, pond, river, stream, etc. so that it can be easily seen by any fish that may be nearby. Alternatively, the fishing line 26 and the hook or lure 29 can be dropped into the body of water before the shaft 90 is positioned in the notches 82 and 84. The shaft 90 is free to turn, rotate or pivot within the notches 82 and 84 to permit the jig pole 12 to rotate or pivot about the holding member 66. The jig pole 12 can be utilized in this position to catch fish. However, if one wishes to jig the jig pole 12, a person simply applies pressure to the terminal end 22 of the handle 14. This will cause the terminal end 22 of the handle 14 to move downward and will cause the angle theta θ to increase relative to the body of water 104. Simultaneously, the tip 30 of the jig pole 12 will move upward. This action will cause the hook or lure 29, and any attached bait, to move or jerk vertically upward within the body of water 104. Such vertical movement can be rather rapid, sudden and erratic so as to attract the attention of any fish that may be lurking nearby. As the pressure is removed, the terminal end 22 of the handle 14 will move upward due to the weight of the fishing reel 16 wanting to return to its original position. This in turn will cause the tip 30 of the jig pole 12 to move downward and allow the hook or lure 29, and any attached bait, to fall back down to its initial height within the body of water 104. The downward movement can be slow relative to the upward movement. The weight of the fishing reel 16 provides the counter weight to allow the hook or lure 29 to move downward through the body of water 104. Pressure can then be reapplied to repeat the process.

It should be understood that a person can apply intermittent pressure to the terminal end 22 of the handle 14 by using one or more fingers, a thumb, a hand or a foot. It is also possible for a person to use an intermediary device, such as a stick, to actuate the terminal end 22 of the handle 14. A person can operate the jig pole 12 with his or her bare hand, with a hand covered by a glove or mitten, or by using the tip of his or her shoe or boot. When a person uses his or her foot to tap the terminal end 22 of the handle 14, the person will have both hands available. This will allow the person to perform other functions, such as drinking a cup of coffee or soda, or using a cell phone while continuing to jig the jig pole 12 using the tip of one foot. If the person wishes to stop jigging for a period of time, this is possible since the weight of the fishing reel 16 will provide resistance to any fish bite and will assist in setting the hook or lure 29 should a fish take the lure 29 or bait. When a fish does bite the hook or lure 29, and any attached bait, the fishing line 26 will be pulled out causing the tip 30 of the jig pole 12 to move downward. The drag on the fishing reel 16 can be preset to slow the withdrawal of the fishing line 26 from the spool 28. The fisherperson will then grab the handle 14 of the jig pole 12 and pull it upward out of the U-shaped holding member 66. The fisherperson would then reel in the fish in a manner used with any fishing pole. Once the fish is caught, it can be kept or released. In either case, the hook or lure 29 can again be baited, if needed, and be dropped back into the body of water 104 so as to be ready to catch another fish.

While the invention has been described in conjunction with a specific embodiment, it is to be understood that many alternatives, modifications and variations will be apparent to those skilled in the art in light of the foregoing description. Accordingly, this invention is intended to embrace all such alternatives, modifications and variations which fall within the spirit and scope of the appended claims.

I claim:

1. A holder capable of holding and allowing a jig pole to pivot, said jig pole having a handle designed to have a fishing reel of a predetermined weight secured thereto, said handle having a first end with a flexible, elongated shaft extending outward therefrom and an oppositely aligned terminal end, said holder comprising:
a. a first member having a first end and a second end, an attachment mechanism rotatably secured adjacent to said first end and a holding member rotatably secured adjacent to said second end, said holding member having a pair of spaced apart upright legs each having a terminal end with a notch formed therein;
b. a second member including a shaft having a first end, a second end and a length therebetween which can span across said pair of spaced apart upright legs, said shaft having a width dimension which fits within each of said notches, and said shaft being secured to a collar having an inside opening which is of sufficient size to encircle said handle; and
c. an adjustable member capable of securing said collar to said handle, forward of said fishing reel, such that said weight of said fishing reel retains said jig pole at an acute angle relative to a body of water, and said shaft can rotate within said notches to permit said jig pole to pivot about said holding member when pressure is applied to said terminal end of said handle.

2. The holder of claim 1 wherein said attachment mechanism is pivotably secured to said first member by a pin.

3. The holder of claim 2 wherein said attachment mechanism is aligned perpendicular to said first member.

4. The holder of claim 3 wherein said holding member is pivotably secured to said first member by a pin.

5. The holder of claim 4 wherein said holding member is aligned perpendicular to said first member.

6. The holder of claim 5 wherein said holding member extends outward from said first member in an opposite direction from said attachment mechanism.

7. The holder of claim 1 wherein said attachment mechanism includes a pair of spaced apart legs joined together by a base member, said base member being pivotably secured to said first member, and one of said legs having a threaded bore formed therethrough, and a fastener extends through said threaded bore for securing said attachment mechanism to a stationary object.

8. The holder of claim 1 wherein said holding member is a U-shaped member.

9. The holder of claim 8 wherein said U-shaped member has a width dimension, measured horizontally between said pair of spaced apart upright legs, which is less than a height dimension, measured perpendicular to said width dimension and extending from a bottom surface of said U-shaped member to said terminal end of one of said pair of spaced apart upright legs.

10. A holder capable of holding and allowing a jig pole to pivot, said jig pole having a handle designed to have a fishing reel of a predetermined weight secured thereto, said handle having a first end with a flexible, elongated shaft extending outward therefrom and an oppositely aligned terminal end, said holder comprising:
a. a first member having a first end and a second end and having a reinforcement rib formed between said first and second ends, an attachment mechanism rotatably secured adjacent to said first end and a U-shaped holding member rotatably secured adjacent to said second end, said U-shaped holding member having a pair of spaced apart upright legs each having a terminal end with a rounded notch formed therein;
b. a second member including a cylindrical shaft having a first end, a second end and a length therebetween which can span across said pair of spaced apart upright legs, said cylindrical shaft having a diameter which is smaller than each of said rounded notches, and said cylindrical shaft being secured to a collar having an inside opening which is of sufficient size to encircle said handle; and
c. an adjustable member capable of securing said collar to said handle, forward of said fishing reel, such that said weight of said fishing reel retains said jig pole at an acute angle relative to a body of water, and said shaft can rotate within said notches to permit said jig pole to pivot about said holding member when pressure is applied to said terminal end of said handle.

11. The holder of claim 10 wherein said reinforcement rib has an inverted V-shape.

12. The holder of claim 11 wherein said attachment mechanism is rotatably secured to said first member by a rivet and said rivet is spaced apart from said reinforcement rib.

13. The holder of claim 10 wherein said first and second ends of said cylindrical shaft are enlarged to prevent said cylindrical shaft from sliding outward beyond either of said pair of spaced apart legs.

14. The holder of claim 10 wherein said collar has a central axis, and said cylindrical shaft is secured to an outside surface of said collar and is aligned perpendicular to said central axis.

15. The holder of claim 10 wherein said collar is a circular ring having a dimension of at least about 0.05 inches between said outside surface and said inside opening, and said inside opening has a diameter of at least about 1 inch.

16. A holder capable of holding and allowing a jig pole to pivot, said jig pole having a handle designed to have a fishing reel of a predetermined weight secured thereto, said handle having a first end with a flexible, elongated shaft extending outward therefrom and an oppositely aligned terminal end, said holder comprising:
a. a first member having a first end and a second end, an attachment mechanism rotatably secured adjacent to said first end and a U-shaped holding member rotatably secured adjacent to said second end, said U-shaped holding member having a pair of spaced apart upright legs each having a terminal end with a U-shaped notch formed therein;
b. a second member including a cylindrical shaft having an enlarged first end, an enlarged second end and a length therebetween which can span across said pair of spaced apart upright legs, said cylindrical shaft having a diameter which is smaller than each of said U-shaped notches and which is removable therefrom, and said cylindrical shaft being secured to a collar having an inside opening which is of sufficient size to encircle said handle; and
c. an adjustable member capable of securing said collar to said handle, forward of said fishing reel, such that said weight of said fishing reel retains said jig pole at an acute angle relative to a body of water, and said shaft can rotate within said notches to permit said jig pole to pivot about said holding member when pressure is intermittently applied to said terminal end of said handle.

17. The holder of claim 16 wherein said U-shaped notch formed in said terminal end of each of said pair of spaced apart upright legs has a width dimension, measured horizontally between said pair of spaced apart legs, which is less than a height dimension, measured perpendicular to said width dimension and extending from a bottom surface of said U-shaped member to said terminal end of one of said pair of legs.

18. The holder of claim 16 wherein said fishing rod is retained by said holding member at an angle of from between about 10 degrees to about 75 degrees relative to a body of water.

19. The holder of claim 16 wherein said adjustable member is a thumb screw aligned perpendicular to said cylindrical shaft.

20. The holder of claim 19 wherein said thumb screw is positioned on an opposite side of said fishing rod handle from said fishing reel.
